(19) United States
(12) Patent Application Publication
(10) Pub. No.: US 2003/0131056 A1
(43) Pub. Date: Jul. 10, 2003

(54) Method and system of distributing teaching data for image processing apparatus

(76) Inventors: Noriyuki Suzuki, Kakegawa-shi (JP); Kenichi Sato, Nara-shi (JP); Suehiro Tanaka, Kofu-shi (JP); Shigeo Masaki, Takatsuki-shi (JP); Kenichi Kaida, Matsuyama-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/216,901

(22) Filed: Aug. 13, 2002

(30) Foreign Application Priority Data
Aug. 14, 2001 (JP) 2001-246024

(51) Int. Cl. G06F 15/16

(52) U.S. Cl. 709/204

(57) ABSTRACT

Based on the result of a teaching operation for recognizing and examining a subject component in an image processing apparatus, there is created teaching data containing data specific to an image processing apparatus that executed the teaching operation, and the teaching data is electronically distributed to image processing apparatus other than the image processing apparatus that executed teaching to enable use of the teaching data for image-processing in other image processing apparatus.

### BACKGROUND OF THE PRESENT INVENTION

The present invention relates to equipment for use in factories, and particularly relates to a method and system of distributing teaching data for image processing apparatus for use in an electronic component mounting process.

First, description will be given of a conventional method of distributing teaching data for image processing apparatuses. FIG. 10 is a view showing a conventional distributing method. In FIG. 10, reference numeral 1 denotes an image processing apparatus that executed teaching. Reference numeral 2 is another image processing apparatus. Reference numeral 3 denotes a teaching data storage apparatus. Reference numeral 7 denotes a record medium.

In FIG. 10, first there is conducted teaching of the image processing apparatus of a subject article in the image processing apparatus 1. The teaching data is stored in the record medium 7 by the teaching data storage apparatus 3. For diverting the teaching data to the another image processing apparatus 2 that is of the same kind as the image processing apparatus 1 that conducted teaching, the record medium 7 is used.

In the electronic component mounting process, image processing apparatuses are used in an electronic component mounting apparatus for wide application including position detection and examination etc. of electronic components. Since subject articles in the field of electronic component mounting are relatively standardized, most equipment used therein is also standardized.

However, kinds and component number of the subject articles are considerably large, so that data per user and per kind of circuits is extremely complicated. Further, in the case of the image processing apparatuses, teaching data specific to each apparatus is necessary for every component, in addition to which specific know-how is necessary for the teaching in most of the cases, so that the data turns out to be most difficult to manage and most complicated among the equipment. If the teaching date is not appropriate, there is naturally generated errors and misdetection. Therefore, creation of teaching data of the image processing apparatuses in the field of mounting is very important, and efficient diversion thereof to other apparatuses is important. However, there is an issue that conventional distribution of the data only through a record media is quite insufficient.

Accordingly, for solving the above issue, it is an object of the present invention to provide a method and system of distributing teaching data for image processing apparatus enabling highly-efficient use of the teaching data in other image processing apparatuses and enabling reduction of errors and misdetection.

### SUMMARY OF THE PRESENT INVENTION

In order to accomplish the above object, the present invention is structured as shown below.

According to a first aspect of the present invention, there is provided a method of distributing teaching data for an image processing apparatus, comprising:

creating teaching data containing data specific to an image processing apparatus that executed a teaching operation, based on a result of the teaching operation for recognizing and examining a subject component in the image processing apparatus; and

electronically distributing the created teaching data to another image processing apparatus other than the image processing apparatus that executed teaching to enable use of the teaching data for image processing in the another image processing apparatus.

According to a second aspect of the present invention, there is provided the method of distributing teaching data for an image processing apparatus as defined in the first aspect, wherein the subject component is an electronic component sucked by a suction nozzle for an electronic component mounting apparatus in a field of electronic component mounting, and the image processing in the image processing apparatus is image-processing in an examination apparatus for recognizing and examining the electronic component.

According to a third aspect of the present invention, there is provided the method of distributing teaching data for an image processing apparatus as defined in the first aspect, wherein the subject component is an electronic component sucked by a suction nozzle for an electronic component mounting apparatus in a filed of electronic component mounting, and the image processing in the image processing apparatus is used for position detection processing of the electronic component in an electronic component mounting step.

According to a fourth aspect of the present invention, there is provided a system of distributing teaching data for an image processing apparatus, comprising:

a teaching data creation device for creating teaching data containing data specific to an image processing apparatus that executed a teaching operation, based on a result of the teaching operation for recognizing and examining a subject component; and

a distribution device for electronically distributing the teaching data created by the teaching data creation device to another image processing apparatus other than the image processing apparatus that executed teaching to enable use of the teaching data for image processing in the another image processing apparatus.

According to a fifth aspect of the present invention, there is provided the system of distributing teaching data for an image processing apparatus as defined in the fourth aspect, wherein the subject component is an electronic component sucked by a suction nozzle for an electronic component mounting apparatus in a filed of electronic component mounting, and the image processing apparatus is provided on an examination apparatus for recognizing and examining the electronic component.

According to a sixth aspect of the present invention, there is provided the system of distributing teaching data for an image processing apparatus as defined in the fourth aspect, wherein the subject component is an electronic component sucked by a suction nozzle for an electronic component mounting apparatus in a filed of electronic component mounting, and the image processing in the image processing apparatus is used for position detection processing of the electronic component in an electronic component mounting step.

According to a seventh aspect of the present invention, there is provided the method of distributing teaching data for an image processing apparatus as defined in the first aspect, wherein the teaching operation comprises of:

sucking an electronic component to be mounted on a circuit forming body, by a suction nozzle; and

recognizing and examining the electronic component sucked by the suction nozzle as the subject component in the image processing apparatus.

According to an eighth aspect of the present invention, there is provided the system of distributing teaching data for an image processing apparatus as defined in the fourth aspect, wherein the teaching operation by the teaching data creation device comprises of sucking an electronic component to be mounted on a circuit forming body, by a suction nozzle, and recognizing and examining the electronic component sucked by the suction nozzle as the subject component in the image processing apparatus.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1 is an explanatory view showing a method of distributing teaching data for image processing apparatus in a first embodiment of the present invention;

FIG. 2 is an explanatory view showing a system of distributing teaching data for image processing apparatus in a second embodiment of the present invention;

FIG. 3 is an explanatory view showing a method of distributing teaching data for image processing apparatus in a third embodiment of the present invention;

FIG. 4 is an explanatory view showing a system of distributing teaching data for image processing apparatus in a fourth embodiment of the present invention;

FIG. 5 is an explanatory view showing a method of distributing teaching data for image processing apparatus in a fifth embodiment of the present invention;

FIG. 6 is an explanatory view showing a system of distributing teaching data for image processing apparatus in a sixth embodiment of the present invention;

FIG. 7 is a view showing a system configuration of the system of distributing teaching data for image processing apparatus of the second embodiment of the present invention in a practical application method;

FIG. 8 is a view showing a system configuration of the system of distributing teaching data for image processing apparatus of the fourth embodiment of the present invention in a practical application method;

FIG. 9 is a view showing a system configuration of the system of distributing teaching data for image processing apparatus of the sixth embodiment of the present invention in a practical application method;

FIG. 10 is an explanatory view showing a conventional method of distributing teaching data for image processing apparatus; and

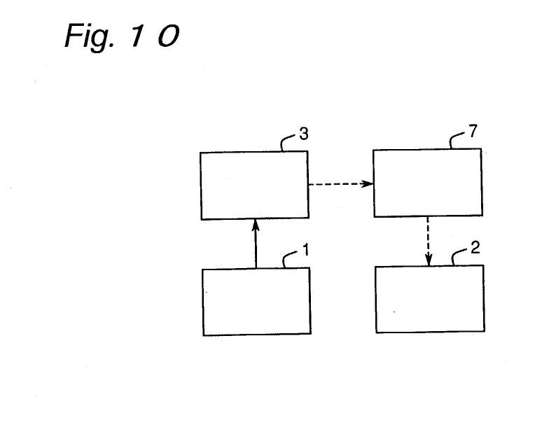

FIG. 11 is a perspective view showing a component mounting apparatus applied to the method of distributing teaching data for image processing apparatus of the first embodiment of the present invention.

### DETAILED DESCRIPTION OF THE PREFERRED EMBODIMENTS

Before the description of the present invention proceeds, it is to be noted that like parts are designated by like reference numerals throughout the accompanying drawings.

Hereinbelow, the embodiments of the present invention will be described in detail with reference to the accompanying drawings.

(First Embodiment)

In the method of distributing teaching data for image processing apparatus in the first embodiment of the present invention, it is characterized in that the teaching data, which is created as a result of executing a teaching operation for recognizing and examining a subject component in an image processing apparatus and which contains data specific to the image processing apparatus that executed the teaching operation, is electronically distributed for use in the image processing apparatus that conducted teaching of the teaching data and in an image processing apparatus other than the image processing apparatus.

Specific description is hereinafter given of the method of distributing teaching data for image processing apparatus in the first embodiment of the present invention with reference to the drawing.

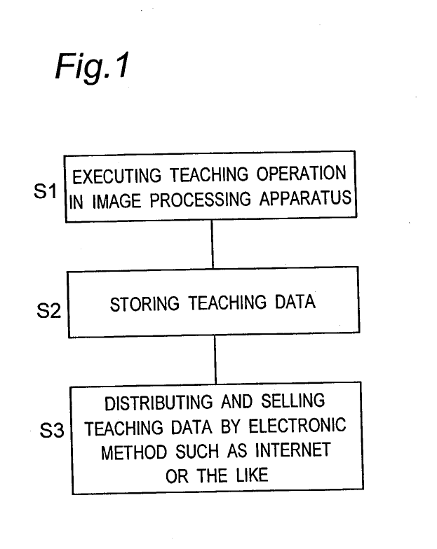

FIG. 1 is an explanatory view showing the method of distributing teaching data for image processing apparatus in the first embodiment of the present invention.

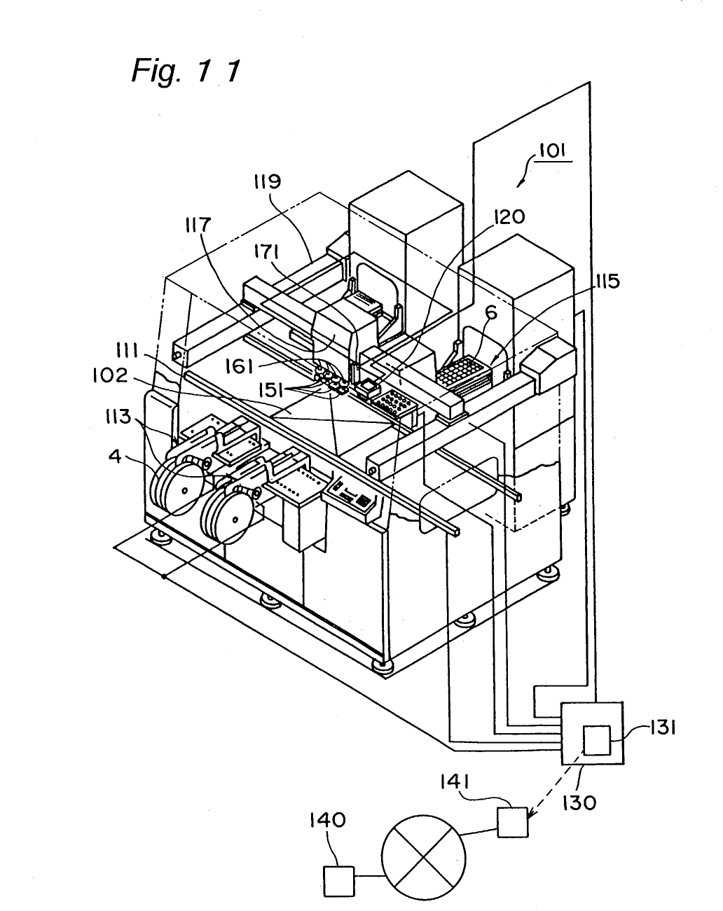

In FIG. 1, first in the step S1, there are executed teaching operations for recognizing and examining subject components (e.g., electronic components) in an image processing apparatus to obtain teaching data containing data specific to the image processing apparatus that conducted the teaching operations. For example, generally in a component mounting step as shown as an example in FIG. 11, from electronic component feeding units 113, 115 such as a parts cassette 4 and a tray 6 storing a number of electronic components, the electronic components are sucked and held by suction nozzles 161, and then sucking and holding postures of the electronic components by the suction nozzles 161 are recognized by the image processing apparatus 120 functioning as a recognition apparatus. After that, based on a recognition result, there are performed correction of rotation around central axes of the suction nozzles 161 and correction of positions against a circuit forming body, e.g., a circuit board 102, on which the electronic components are to be placed, along two directions that are orthogonal along the surface of the circuit board, and then the electronic components are mounted on the circuit board 102. At this point, for removing recognition error due to characteristics of the electronic components themselves such as the forms and colors of the electronic components sucked and held by the suction nozzles 161, it is necessary to carry out teaching operations about rotations and positions of electronic components exemplifying subject articles in the image processing apparatus 120. As an example of the teaching operations, electronic components for teaching 151 (e.g., electronic components to be mounted on the circuit forming body 102) are sucked and held by the nozzles 161 in predetermined suction and holding postures, in the state of which images of the electronic components for teaching 151 are recognized by the image processing apparatus 120 to obtain difference between the predetermined suction and holding postures and the recognition result, thereby obtaining teaching data. The teaching data, that is the difference, is subtracted from the recognition data in recognition processing of the electronic components so as to remove mounting difference of the recognition apparatus 120 against a base of a component electronic component mounting apparatus 101. The teaching data contains data specific to the image processing apparatus that executed the teaching operations, i.e., format-like data for the teaching data of the respective image processing apparatus. The teaching data in this case is not necessarily the data peculiar to components, but may contain data for increasing capability of the entire image processing apparatus functioning as a recognition apparatus (e.g., data for selecting whether to use an upgrade function when the version of a software of the entire image processing apparatus is upgraded). Also, as image data in the teaching data, there are not only simple two-dimensional signals of a monochrome camera exemplifying a recognition camera, but also color information, three-dimensional height information of laser scan and the like (e.g., height information of bump electrodes on the lower faces of semiconductor devices such as CSPs and BGAs), X-ray images, and ultrasonic images, and in terms of number of dimension, there are one-dimensional images of a line sensor exemplifying a recognition camera, and three-dimensional images obtained by superimposing two-dimensional images.

Next in the step S2, the teaching data is stored in a medium that is a storage medium such as floppy disks and CD-ROM by a data storage apparatus 131 connected to a control apparatus 130.

Then in the step S3, the stored teaching data is distributed to another apparatus 140 by an electronic method such as Internet or LAN (e.g., use of a data distribution device 141 that is a data transfer system such as Internet or LAN) to sell the teaching data. It is noted that in FIG. 11, reference numeral 111 denotes a board transportation apparatus for transporting boards 2, 117 denotes a placement head for elevating and rotating suction nozzles 161, 119 denotes an XY robot for enabling movement of the placement head 117 in orthogonal X and Y directions, and 130 denotes a control apparatus for controlling operation of each apparatus and member.

As described above, according to the first embodiment of the present invention, the teaching data created as a result of executing the teaching operations is electronically distributed to the another apparatus so as to be used in image processing in the image processing apparatus that executed teaching and in an image processing apparatus other than the image processing apparatus, which can implement highly efficient use of the teaching data in other image processing apparatuses, and can reduce errors and misdetection. In other words, highly accurate recognition and examination may be performed only with use of the distributed teaching data without re-execution of the teaching operations in other image processing apparatuses, thereby enabling omission or simplification of the teaching operations, while enabling prevention of errors and misdetection generated in executing similar teaching operations in other image processing apparatuses, resulting in efficient prevention of occurrence of errors and misdetection as a whole. This enables a brand new business in which the teaching data is managed by a manufacturer of image processing apparatuses or a third-party provider and distributed on demand to the image processing apparatuses of each user through Internet and the like, and the distribution is charged or included in after service provided after sale of the image processing apparatuses.

(Second Embodiment)

In the system of distributing teaching data for image processing apparatus in the second embodiment of the present invention, the teaching data, which is created as a result of executing teaching operations for recognizing and examining subject components (e.g., an electronic components) in an image processing apparatus and which contains data specific to the image processing apparatus that executed the teaching operations, is distributed by a distribution device that performs electronic distribution for use in the image processing apparatus that conducted teaching of the teaching data and in an image processing apparatus other than the image processing apparatus.

Specific description is hereinafter given of the system of distributing teaching data for image processing apparatus in the second embodiment of the present invention with reference to the drawing.

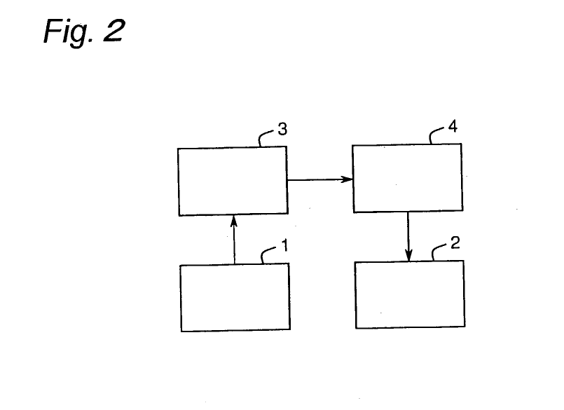

FIG. 2 is an explanatory view showing the system of distributing teaching data for image processing apparatus in the second embodiment of the present invention. In FIG. 2, reference numeral 1 denotes an image processing apparatus that executed teaching as an example of a teaching data creation device (corresponding to, for example, the image processing apparatus 120 of FIG. 11). Reference numeral 2 denotes another image processing apparatus (corresponding to, for example, another apparatus 140 of FIG. 11). Reference numeral 3 denotes a teaching data storage apparatus (corresponding to, for example, the data storage apparatus 131 of FIG. 11). Reference numeral 4 denotes a data distribution device (corresponding to, for example, the data distribution device 141 of FIG. 11). In FIG. 2, firstly, there is conducted teaching of the image processing apparatus of subject articles in the image processing apparatus 1. Then, the teaching data is stored in the teaching data storage apparatus 3. For diverting the teaching data to another image processing apparatus 2 that is of the same kind as the image processing apparatus 1 that conducted teaching, the data is distributed from the teaching data storage apparatus 3 to the another image processing apparatus 2 via the data distribution device 4. The data distribution device 4 is a data transfer system such as Internet or LAN.

Although in the previous description, teaching is carried out in the image processing apparatus 1 that executed teaching for better understanding, the image processing apparatus 1 that executed teaching is not always necessary, so that the teaching data may be created by an apparatus other than the image processing apparatus 1 as another example of a teaching data creation device, and then stored in the teaching data storage apparatus 3. For example, basic teaching may be executed in the image processing apparatus 1, and the data thereof may be stored in the teaching data storage apparatus 3. Then after checked and corrected by a different apparatus for checking and correction, the stored data may be distributed to another image processing apparatus 2 via the data distribution device 4. In this case, the image processing apparatus 1 and the apparatus for checking and correction function as examples of the teaching data creation device. In addition, another image processing apparatus 2 is not exactly necessary, so that the data stored in the teaching data storage apparatus 3 may be checked and corrected by another apparatus and then distributed to the image processing apparatus 2 via the data distribution device 4. Further, a distribution destination is not necessarily the image processing apparatus 2, and distribution may be performed via a data storage apparatus. Also, the teaching data in this case is not necessarily the data peculiar to components, but may contain data for increasing capability of the entire image processing apparatus functioning as a recognition apparatus. Also, as image data contained in the teaching data, there are not only simple two-dimensional signals of a monochrome camera exemplifying a recognition camera, but also color information, three-dimensional height information of laser scan and the like, X-ray images, and ultrasonic images, and in terms of number of dimension, there are one-dimensional images of a line sensor exemplifying a recognition camera, and three-dimensional images obtained by superimposing two-dimensional images.

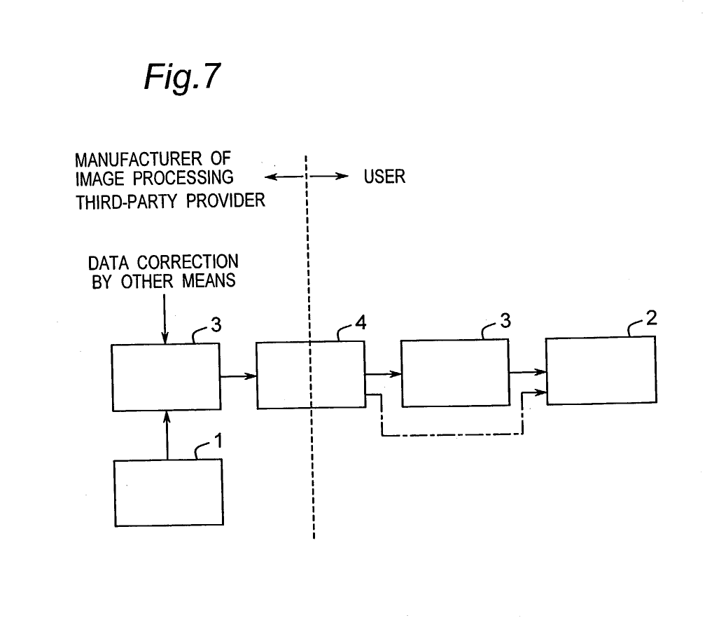

As a specific application method of the second embodiment of the present invention, there may be considered that the teaching data storage apparatus 3 and the teaching data stored therein are managed by a manufacturer of image processing apparatuses and sold to the image processing apparatuses of each user on demand. The system structure of this specific application method is shown in FIG. 7. Here, if the manufacturer of the image processing apparatuses and the users thereof are different companies, a brand new business involving electronic transaction of teaching data for image processing apparatuses becomes feasible. Also, the teaching data may be managed and dealt not necessarily by the manufacturer of the image processing apparatuses but by an absolute third party.

As stated in the prior art description, creation of the teaching data for image processing apparatuses is of great importance and therefore it may be considered as an amassment of manufacturing-know-how in factories. More specifically, if the teaching data is finely made up in one machine, the information on teaching-know-how is greatly worth selling as a precious means for reducing error and misdetection rates. Use of electronic distribution such as Internet makes it possible to efficiently make a business of selling such know-how information.

As described above, according to the second embodiment of the present invention, the teaching data created as a result of executing teaching operations is distributed by the data distribution device 4 that performs electronic distribution to enable use of the teaching data in the image processing apparatus 1 that executed teaching and in an image processing apparatus 2 other than the image processing apparatus, which implements highly efficient use of the teaching data in other image processing apparatuses, as well as reduction of errors and misdetection. In other words, highly accurate recognition and examination may be performed only with use of the teaching data distributed by the data distribution device 4 without re-execution of the teaching operation in another image processing apparatus 2, thereby enabling omission or simplification of the teaching operations in the another image processing apparatus 2, while enabling prevention of errors and misdetection generated in executing similar teaching operations in another image processing apparatus 2, resulting in efficient prevention of occurrence of errors and misdetection as a whole. This enables a brand new business in which the teaching data is managed by a manufacturer of image processing apparatuses or a third-party provider and distributed on demand to the image processing apparatuses of each user through Internet or the like.

(Third Embodiment)

The method of distributing teaching data for image processing apparatus in the third embodiment of the present invention has such a feature, similar to the first embodiment, that the teaching data, which is created as a result of executing teaching operations for recognizing and examining subject components in an image processing apparatus and which contains data specific to the image processing apparatus that executed the teaching operations, is electronically distributed for use in the image processing apparatus that conducted teaching of the teaching data and in an image processing apparatus other than the image processing apparatus, while at the same time, additionally, the method has a feature that the image processing apparatus is used for a detection apparatus in the field of electronic component mounting, in which the subject components are electronic components in the field of electronic component mounting, and the image processing by the image processing apparatus is image-processing by a detection apparatus for recognizing and examining the electronic component.

Specific description is hereinafter given of the method of distributing teaching data for image processing apparatus in the third embodiment of the present invention with reference to the drawing.

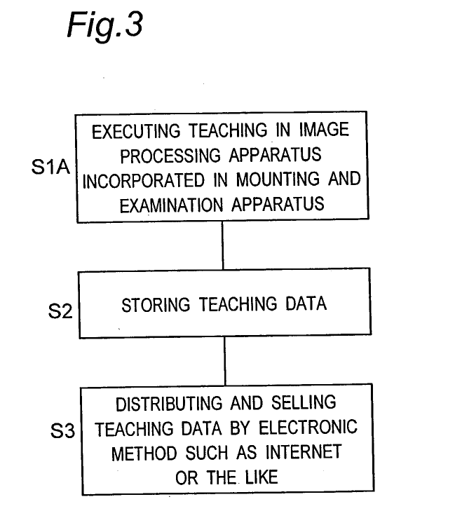

FIG. 3 is an explanatory view showing the method of distributing teaching data for image processing apparatus in the third embodiment of the present invention.

In FIG. 3, first in the step S1A, there are executed teaching operations for recognizing and examining subject articles (e.g., electronic components) in an image processing apparatus incorporated in a mounting and examination apparatus to obtain teaching data containing data specific to the image processing apparatus that executed the teaching operations. The teaching data in this case is not necessarily the data peculiar to components, but may contain data for increasing capability of the entire image processing apparatus functioning as a recognition apparatus. Also, as image data contained in the teaching data, there are not only simple two-dimensional signals of a monochrome camera exemplifying a recognition camera, but also color information, three-dimensional height information of laser scan and the like, X-ray images, and ultrasonic images, and in terms of number of dimension, there are one-dimensional images of a line sensor exemplifying a recognition camera, and three-dimensional images obtained by superimposing two-dimensional images.

Further, a content of the recognition and examination in mounting includes solder printing states, presence of components, solder bonding states, and the like. As stated in the prior art description, creation of the teaching data for image processing apparatuses is of great importance, specifically, in the field of mounting. Since subject articles in the field of electronic component mounting are relatively standardized, most equipment used therein is also standardized. Consequently, as a business, there is expected a profit by sale of standard articles in the form of standard teaching data relating to standard electronic components. Further, as for an examination function, with advance of an examination content, most of the teaching data becomes complicated for bringing out the capability of the function to the fullest extent. Also, a sensing apparatus treats various information including not only signals of a monochrome camera exemplifying a recognition camera, but also color information, three-dimensional height information, and X-ray and ultrasonic information, which also complicates the teaching data containing these information.

Next in the step S2, the teaching data is stored in a medium that is a storage medium such as floppy disks and CD-ROM.

Then in the step S3, the stored teaching data is distributed to other apparatuses by an electronic method such as Internet or LAN for selling the teaching data.

As described above, according to the third embodiment of the present invention, the teaching data created as a result of executing teaching operations is electronically distributed to another apparatus, so that the teaching data can be used in the image processing apparatus that executed teaching and in an image processing apparatus other than the image processing apparatus for use as an examination apparatus in the field of electronic component mounting. This implements highly efficient use of the teaching data in other image processing apparatuses, and implements reduction of errors and misdetection, thereby making it possible to increase reliability of examination of electronic components. In other words, highly accurate recognition and examination may be performed only with use of the distributed teaching data without re-execution of the teaching operations in other image processing apparatuses, thereby enabling omission or simplification of the teaching operations in other image processing apparatuses, while enabling prevention of errors and misdetection generated in executing similar teaching operations in other image processing apparatuses, resulting in efficient prevention of occurrence of errors and misdetection as a whole and increase in reliability of examination of electronic components. This enables a brand new business in which the teaching data is managed by a manufacturer of image processing apparatuses, a manufacturer of mounting and examination apparatuses, or a third-party provider, and the teaching data is distributed on demand to the image processing apparatuses of each user of the mounting and examination apparatuses through Internet or the like. Since subject articles in the field of electronic component mounting are relatively standardized, most equipment used therein is also standardized. Consequently, as a business, there may be expected a profit by sale of standard articles. Further, as for an examination function, with advance of an examination content and development of a sensing apparatus, most of the teaching data becomes complicated for bringing out the capability of the function to the fullest extent, so that the effect thereof is large. More specifically, in the mounting and examination apparatuses, their examination content covers considerably wide range including solder printing states before placing, positional displacements after placing, and solder states after reflow even in the-case of the same subject components, so that their examination parameters tend to be complicated, thereby making the teaching data complex. According to the above embodiment, however, the teaching data may be used in other image processing apparatuses quite efficiently, which makes it possible to reduce errors and misdetection and to increase reliability of examination of electronic components.

(Fourth Embodiment)

The system of distributing teaching data for image processing apparatus in the fourth embodiment of the present invention has such a feature, similar to the second embodiment, that the teaching data, which is created as a result of executing teaching operations for recognizing and examining subject components in an image processing apparatus and which contains data specific to the image processing apparatus that executed the teaching operations, is distributed by a data distribution device that performs electronic distribution for use in the image processing apparatus that conducted teaching of the teaching data and in an image processing apparatus other than the image processing apparatus, while at the same time the system also has such a feature that the image processing apparatus: is used for a detection apparatus in the field of electronic component mounting, in which the subject components are electronic components in the field of electronic component mounting, and the image processing apparatus is provided on an examination apparatus for recognizing and examining the electronic components.

Specific description is hereinafter given of the system of distributing teaching data for image processing apparatus in the fourth embodiment of the present invention with reference to the drawing.

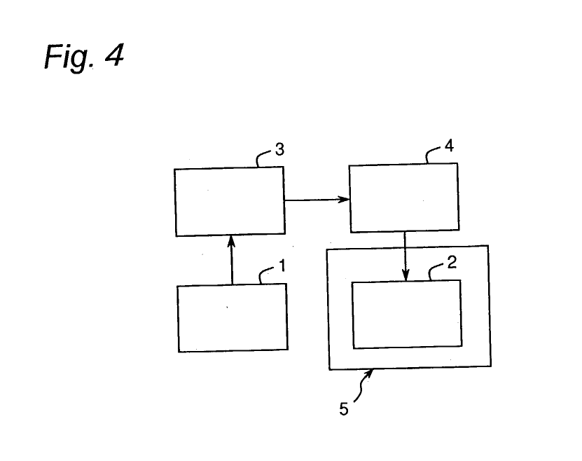

FIG. 4 is an explanatory view showing the system of distributing teaching data for image processing apparatus in the fourth embodiment of the present invention. In FIG. 4, component members identical to those in FIG. 2 are designated by identical reference numerals and the description thereof will be omitted. In FIG. 4, reference numeral 5 denotes an electronic component mounting and examination apparatus.

In FIG. 4, first in an image processing apparatus 1 that executed teaching (corresponding to, for example, the image processing apparatus 120 of FIG. 11), there is performed teaching of the image processing apparatus of subject articles. Then, in a teaching data storage apparatus 3 (corresponding to, for example, the data storage apparatus 131 of FIG. 11), the teaching data is stored. For diverting the teaching data to another image processing apparatus 2 (corresponding to, for example, the another apparatus 140 of FIG. 11) that is of the same kind as the image processing apparatus 1 that conducted teaching, the data is distributed from the teaching data storage apparatus 3 via a data distribution device 4 (corresponding to, for example, the data distribution device 141 of FIG. 11). Here, the another image processing apparatus 2, which is used for examining electronic components and the like in an electronic component mounting and examination apparatus 5, is incorporated in the electronic component mounting and examination apparatus 5. In this case, the data distribution device 4 is a data transfer system such as Internet or LAN.

Further, the electronic component mounting and examination apparatus 5 designates an examination apparatus for examining solder printing states, presence of components, solder bonding states, or the like.

Although in the previous description, teaching is carried out in the image processing apparatus 1 that executed teaching for better understanding, the image processing apparatus 1 that executed teaching is not always necessary, so that the teaching data may be created by another apparatus and then stored in the teaching data storage apparatus 3. For example, basic teaching may be executed in the image processing apparatus 1, and the data thereof may be stored in the teaching data storage apparatus 3. Then after checked and corrected by another apparatus, the stored data may be distributed to the another image processing apparatus 2 via the data distribution device 4. In addition, the another image processing apparatus 2 is not exactly necessary, so that the data stored in the teaching data storage apparatus 3 may be checked and corrected by another apparatus and then distributed to the image processing apparatus 1 via the data distribution device 4. Further, a distribution destination is not necessarily an image processing apparatus, and distribution may be performed via a data storage apparatus. Also, the teaching data in this case is not necessarily the data peculiar to components, but may contain data for increasing capability of the entire image processing apparatus functioning as a recognition apparatus.

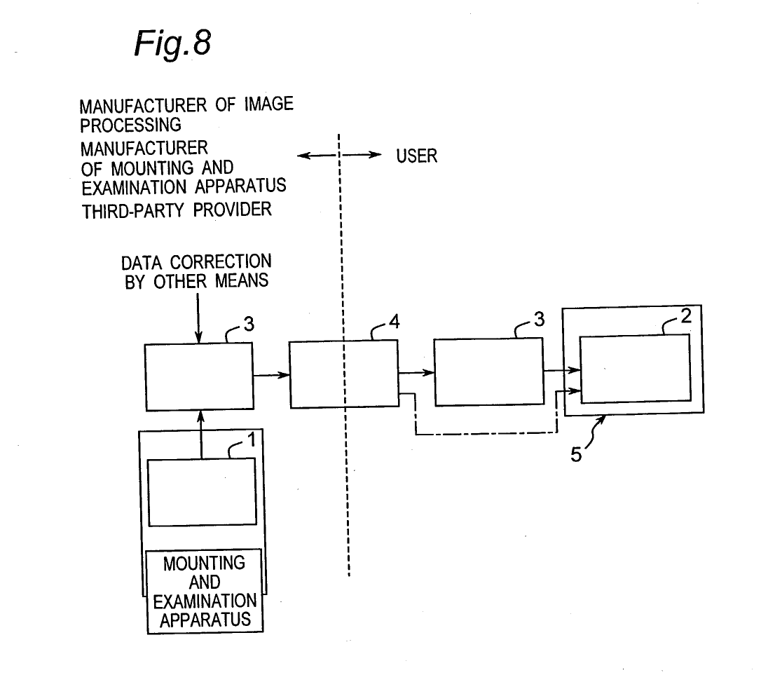

As a specific application method of the fourth embodiment of the present invention, there may be considered that the teaching data storage apparatus 3 and the teaching data stored therein are managed by a manufacturer of image processing apparatuses or a manufacturer of mounting and examination apparatuses, and the teaching data is distributed on demand to the image processing apparatuses of each user of electronic component mounting apparatuses. The system configuration of this specific application method is shown in FIG. 8. The configuration enables a brand new business in which the teaching data is managed by a manufacturer of image processing apparatuses or a manufacturer of mounting and examination apparatuses, and distributed on demand to the image processing apparatuses incorporated in the mounting and examination apparatuses of each user through Internet or the like. Also, the teaching data may be managed and dealt not necessarily by the manufacturer of the image processing apparatuses or the manufacturers of examination apparatuses, but by an absolute third party. As stated in the prior art description, creation of the teaching data for image processing apparatuses particularly in the filed of mounting is of great importance. Since subject articles in the field of electronic component mounting are relatively standardized, most equipment used therein is also standardized. Consequently, as a business, there is expected a profit by sale of standard articles in the form of standard teaching data relating to standard electronic components. Further, as for an examination function, with advance of an examination content, most of the teaching data becomes complicated for bringing out the capability of the function to the fullest extent. Also, a sensing apparatus treats various information including not only signals of a monochrome camera exemplifying a recognition camera, but also color information, three-dimensional height information, and X-ray and ultrasonic information, which also complicates the teaching data.

As described above, according to the fourth embodiment of the present invention, the teaching data created as a result of executing teaching operations is distributed by the data distribution device 4 that performs electronic distribution to enable use of the teaching data in the image processing apparatus 1 that executed teaching and in the another image processing apparatus 2 other than the image processing apparatus 1 for use as the examination apparatus 5 in the field of electronic component mounting. This implements highly efficient use of the teaching data in the another image processing apparatus 2, and implements reduction of errors and misdetection, thereby making it possible to increase reliability of electronic component examination apparatuses. In other words, highly accurate recognition and examination may be performed only with use of the distributed teaching data without re-execution of the teaching operations in the another image processing apparatus 2, thereby enabling omission or simplification of the teaching operations, while enabling prevention of errors and misdetection generated in executing similar teaching operations in the another image processing apparatus 2, resulting in efficient prevention of occurrence of errors and misdetection as a whole as well as increase in reliability of examination of electronic components. This enables a brand new business in which the teaching data is managed by a manufacturer of image processing apparatuses, a manufacturer of mounting and examination apparatuses, or a third-party provider, and the teaching data is distributed on demand to the image processing apparatuses of each user of the mounting and examination apparatuses through Internet or the like. Since subject articles in the field of electronic component mounting are relatively standardized, most equipment used therein is also standardized. Consequently, as a business, there may be expected a profit by sale of standard articles. Further, as for an examination function, with advance of an examination content and development of a sensing apparatus, most of the teaching data becomes complicated for bringing out the capability of the function to the fullest extent, so that the effect thereof is large. More specifically, in the mounting and examination apparatuses, their examination content covers considerably wide range including solder printing states before placing, positional displacement after placing, solder states after reflow, and the like even in the case of the same subject components, so that their examination parameters tend to be complicated, thereby making the teaching data complex. According to the above embodiment, however, the teaching data may be used in other image processing apparatuses quite efficiently, which makes it possible to reduce errors and misdetection and to increase reliability of examination of electronic components.

(Fifth Embodiment)

The method of distributing teaching data for image processing apparatus in the fifth embodiment of the present invention has such a feature, similar to the first embodiment, that the teaching data, which is created as a result of executing teaching operations for recognizing and examining subject components in an image processing apparatus and which contains data specific to the image processing apparatus that executed the teaching operations, is electronically distributed for use in the image processing apparatus that conducted teaching of the teaching data and in an image processing apparatus other than the image processing apparatus, while at the same time the system also has such a feature that the image processing apparatus is used for detecting locations of electronic components in an electronic component mounting apparatus, in which the subject components are electronic components in the field of electronic component mounting, and the image processing by the image processing apparatus is used for location detection processing of the electronic components in an electronic component mounting step.

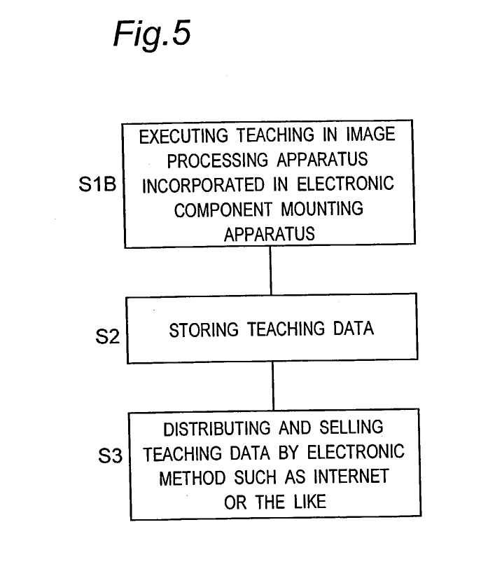

Specific description is hereinafter given of the method of distributing teaching data for image processing apparatus in the fifth embodiment of the present invention with reference to the drawing. FIG. 5 is an explanatory view showing the method of distributing teaching data for image processing apparatus in the fifth embodiment of the present invention.

In FIG. 5, first in the step S1B, there are executed teaching operations of subject articles (e.g., electronic components) in an image processing apparatus incorporated in an electronic component mounting apparatus to obtain teaching data containing data specific to the image processing apparatus that executed the teaching operations. Here the image processing apparatus is mainly used for obtaining locations of electronic components and boards in mounting the electronic components on the circuit boards.

Next in the step S2, the teaching data is stored in a medium that is a storage medium such as floppy disks or CD-ROM.

Then in the step S3, the stored teaching data is distributed to other apparatuses by an electronic method such as Internet or LAN to sell the teaching data.

As stated in the prior art description, creation of the teaching data for image processing apparatuses particularly in the filed of electronic component mounting is of great importance. Since subject articles in the field of electronic component mounting are relatively standardized, most equipment used therein is also standardized. Consequently, as a business, there is expected a profit by sale of standard articles in the form of standard teaching data relating to standard electronic components. Further, a positioning function of most electronic component mounting apparatuses is almost the same in terms of image processing even if the configuration of the electronic component mounting apparatuses is changed, so that the same kind of development is possible even if the electronic component mounting apparatuses are different in kind, and therefore further development is expectable.

As described above, according to the fifth embodiment of the present invention, the teaching data created as a result of executing teaching operations is electronically distributed so as to be used in the image processing apparatus that executed teaching and in an image processing apparatus other than the image processing apparatus, which implements highly efficient use of the teaching data in other image processing apparatuses, and implements reduction of errors and misdetection, thereby making it possible to increase operating ratios and placing accuracy of electronic component mounting apparatuses. In other words, highly accurate recognition and examination may be performed only with use of the distributed teaching data without re-execution of the teaching operations in other image processing apparatuses, thereby enabling omission or simplification of the teaching operations, while enabling prevention of errors and misdetection generated in executing similar teaching operations in the other image processing apparatuses, resulting in efficient prevention of occurrence of errors and misdetection as a whole as well as increase in operating ratios and placing accuracy of the electronic component mounting apparatuses. This enables a brand new business in which the teaching data is managed by a manufacturer of image processing apparatuses, a manufacturer of electronic component mounting apparatuses, or a third-party provider, and the teaching data is distributed on demand to the image processing apparatus(es) of each user of the electronic component mounting apparatuses through Internet or the like. Since subject articles in the field of electronic component mounting are relatively standardized, most equipment used therein is also standardized. Consequently, as a business, there may be expected a profit by sale of standard articles. Further, even if the electronic component mounting apparatuses are different in kind, the same kind of development is possible if image processing is the same in kind. More specifically, the recognition operations, i.e., the position detection operations, are performed only for viewing the postures of components by a camera. Eventually, even if the apparatus is changed, parameters of the apparatus generally do not change so much unlike an inspection apparatus as long as the apparatus has similar configuration. It is noted, however, there are some factors of parameter change including a tendency that later-developed apparatus is basically given better performance. Also, there are 2,000 kinds of electronic components for use in one electronic component mounting apparatus, so that users get a strong desire to strictly manage the components having a large number of kinds and some difference by every apparatus. Consequently, according to the above embodiment, highly efficient use of the teaching data in other image processing apparatuses is implemented, and reduction of errors and misdetection is fulfilled, thereby enabling increase of operating ratios and placing accuracy of the electronic component mounting apparatuses.

(Sixth Embodiment)

The system of distributing teaching data for an image processing apparatus in the sixth embodiment of the present invention has such a feature, similar to the second embodiment, that the teaching data, which is created as a result of executing teaching operations for recognizing and examining subject components in an image processing apparatus and which contains data specific to the image processing apparatus that executed the teaching operations, is distributed by a data distribution device that performs electronic distribution for use in the image processing apparatus that conducted teaching of the teaching data and in an image processing apparatus other than the image processing apparatus, while at the same time the system also has a feature that the image processing apparatus is used for detecting position of an electronic component in an electronic component mounting apparatus, in which the subject components are electronic components in the field of electronic component mounting, and the image processing by the image processing apparatus is used for position detection processing of the electronic components in an electronic component mounting step.

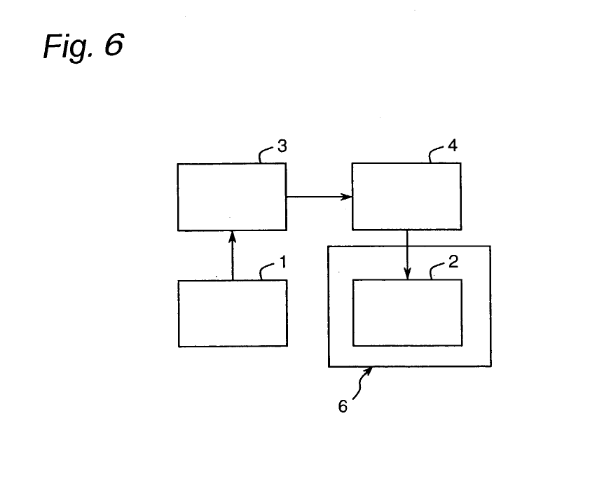

Specific description is hereinafter given of the system of distributing teaching data for image processing apparatus in the sixth embodiment of the present invention with reference to the drawing. FIG. 6 is an explanatory view showing the system of distributing teaching data for an image processing apparatus in the sixth embodiment of the present invention. In FIG. 6, component members identical to those in FIG. 2 are designated by identical reference numerals and the description thereof will be omitted. In FIG. 6, reference numeral 6 denotes an electronic component mounting apparatus.

In FIG. 6, first in an image processing apparatus 1 that executed teaching (corresponding to, for example, the image processing apparatus 120 of FIG. 11), there is performed teaching of an image processing apparatus of subject articles (e.g., electronic components). Then, in a teaching data storage apparatus 3 (corresponding to, for example, the data storage apparatus 131 of FIG. 11), the teaching data is stored. For diverting the teaching data to another image processing apparatus 2 (corresponding to, for example, the another apparatus 140 of FIG. 11) that is of the same kind as the image processing apparatus 1 that conducted teaching, the data is distributed from the teaching data storage apparatus 3 via a data distribution device 4 (corresponding to, for example, the data distribution device 141 of FIG. 11). Here, the another image processing apparatus 2, which is used for detecting position of electronic components, is incorporated in the electronic component mounting apparatus 6. In this case, the data distribution device 4 is a data transfer system such as Internet or LAN.

Although in the previous description, teaching is carried out in the image processing apparatus 1 that executed teaching for better understanding, the image processing apparatus 1 that executed teaching is not always necessary, so that the teaching data may be created by another apparatus and then stored in the teaching data storage apparatus 3. For example, basic teaching may be executed in the image processing apparatus 1, and the data thereof may be stored in the teaching data storage apparatus 3. Then after checked and corrected by an apparatus for checking and correction, the stored data may be distributed to another image processing apparatus 2 via the data distribution device 4. In addition, another image processing apparatus 2 is not exactly necessary, so that the data stored in the teaching data storage apparatus 3 may be checked and corrected by an apparatus for checking and correction and then distributed to the image processing apparatus 1 via the data distribution device 4. Further, a distribution destination is not necessarily an image processing apparatus, and distribution may be performed via a data storage apparatus. Also, the teaching data in this case is not necessarily only the data peculiar to components, but may contain data for increasing capability of the entire image processing apparatus functioning as a recognition apparatus.

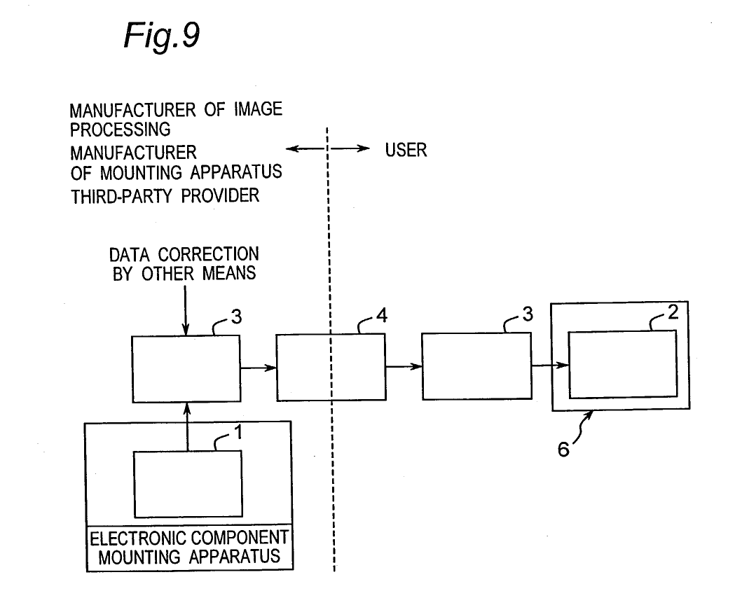

As a specific application method of the sixth embodiment of the present invention, there may be considered that the teaching data storage apparatus 3 and the teaching data stored therein are managed by a manufacturer of image processing apparatuses or a manufacturer of electronic component mounting apparatuses, and distributed on demand to the image processing apparatus(es) of each user of electronic component mounting apparatuses. The system configuration of this specific application method is shown in FIG. 9. The configuration enables a brand new business in which the teaching data is managed by a manufacturer of image processing apparatuses or a manufacturer of electronic component mounting apparatuses, and distributed on demand to the image processing apparatus(es) incorporated in the electronic component mounting apparatus(es) of each user through Internet or the like. Also, the teaching data may be managed and dealt not necessarily by the manufacturer of the image processing apparatuses or the manufacturer of electronic component mounting apparatuses, but by an absolute third party. As stated in the prior art description, creation of the teaching data for image processing apparatuses particularly in the filed of mounting is of great importance. Since subject articles in the field of electronic component mounting are relatively standardized, most equipment used therein is also standardized. Consequently, as a business, there is expected a profit by sale of standard articles in the form of standard teaching data relating to standard electronic components. Further, a positioning function of most electronic component mounting apparatuses is almost the same in terms of image processing even if the configuration of the electronic component mounting apparatuses is changed, so that the same kind of development is possible even if the electronic component mounting apparatuses are different in kind, and therefore further development is expectable.

As described above, according to the sixth embodiment of the present invention, the teaching data created as a result of executing teaching operations is distributed by an apparatus that performs electronic distribution to enable use of the teaching data in the image processing apparatus 1 that executed teaching and in another image processing apparatus 2 other than the image processing apparatus 1 both of which are used for detecting positions of electronic components in an electronic component mounting apparatus. This can implement highly efficient use of the teaching data in another image processing apparatus 2, and can implement reduction of errors and misdetection, thereby making it possible to increase an operating ratio and mounting accuracy of the electronic component mounting apparatus. In other words, highly accurate recognition and examination may be performed only with use of the distributed teaching data without re-execution of the teaching operations in the another image processing apparatus 2, thereby enabling omission or simplification of the teaching operations, while enabling prevention of errors and misdetection generated in executing similar teaching operations in the another image processing apparatus 2, resulting in efficient prevention of occurrence of errors and misdetection as a whole as well as increase in the operating ratio and mounting accuracy of the electronic component mounting apparatus. This enables a brand new business in which the teaching data is managed by a manufacturer of image processing apparatuses, a manufacturer of electronic component mounting apparatuses, or a third-party provider, and the teaching data is distributed on demand to the image processing apparatuses of each user of the electronic component mounting apparatuses through Internet or the like. Since subject articles in the field of electronic component mounting are relatively standardized, most equipment used therein is also standardized. Consequently, as a business, there may be expected a profit by sale of standard articles. Further, if the electronic component mounting apparatuses are different in kind, the same kind of development is possible if their image processing is the same in kind. More specifically, the recognition operation, i.e., the position detection operation, is performed only for viewing the posture of a component by a camera. Eventually, even if the apparatus is changed, parameters of the apparatus generally do not change so much like the detection apparatus as long as the apparatus has similar construction. It is noted, however, there are some factors of parameter change including a tendency that later-developed apparatus is basically given better performance. Also, there are, for example, 2,000 kinds of electronic components for use in one electronic component mounting apparatus, so that users get a strong desire to strictly manage the components having a large number of kinds and some difference by every apparatus. Consequently, according to the above embodiment, highly efficient use of the teaching data in other image processing apparatuses is implemented, and reduction of errors and misdetection is fulfilled, thereby enabling increase of an operating ratio and mounting accuracy of the electronic component mounting apparatus.

It is noted that proper combination of arbitrary embodiments among the above-described various embodiments makes it possible to implement the effects of respective embodiments.

According to the first aspect of the present invention, the teaching data created as a result of executing a teaching operation is electronically distributed to another apparatus so as to be used in image processing in the image processing apparatus that executed teaching and in an image processing apparatus(es) other than the image processing apparatus, which implements highly efficient use of the teaching data in other image processing apparatus(es), and reduction of errors and misdetection. In other words, highly accurate recognition and examination may be performed only with use of the distributed teaching data without re-execution of the teaching operation in other image processing apparatuses, thereby enabling omission or simplification of the teaching operation, while enabling prevention of errors and misdetection generated in executing a similar teaching operation in other image processing apparatus(es), resulting in efficient prevention of occurrence of errors and misdetection as a whole. This enables a brand new business in which the teaching data is managed by a manufacturer of image processing apparatuses or a third-party provider and distributed on demand to the image processing apparatuses of each user through Internet and the like, and the distribution is charged or included in after-sales service provided after sale of the image processing apparatuses.

In other words, there is an issue, more particularly an issue peculiar to the teaching data of image processing apparatuses, that the teaching data tends to depend on know-how thereof, so that the teaching data requires test operation in a real machine, that is a component mounting apparatus for practical use, before production of the teaching data. Consequently, in the case where the teaching data created as a result of conducting a teaching operation is distributed only through a record medium, the distribution operation is inefficient and not speedy. Particularly, during an initial phase after development of a new model, the know-how thereof is continuously accumulated every day, where distribution of the teaching data only through a record medium is far from sufficient. In such a case, the teaching data created as a result of conducting a teaching operation in one apparatus is electronically distributed to other apparatuses so as to be used in image processing in the image processing apparatus that carried out teaching and in image processing apparatuses other than the image processing apparatus, while at the same time, if a failure should occur in the other apparatus and so the teaching data including the know-how thereof is renewed, the renewed data may be used in still other apparatus(es) or in the apparatus which created the teaching data at the first place, thereby enabling extremely efficient use of the teaching data in various image processing apparatuses, resulting in reduction of errors and misdetection.

According to the second aspect of the present invention, the teaching data created as a result of executing a teaching operation is electrically distributed to another apparatus so as to be used in the image processing apparatus that executed teaching and in an image processing apparatus other than the image processing apparatus for use in an execution apparatus in the field of electronic component mounting, which implements highly efficient use of the teaching data in other image processing apparatus(es), as well as reduction of errors and misdetection, thereby enabling increase in reliability of examination of electronic components. In other words, highly accurate recognition and examination may be performed only with use of the distributed teaching data without re-execution of the teaching operation in other image processing apparatus(es), thereby enabling omission or simplification of the teaching operation in other image processing apparatus(es), while enabling prevention of errors and misdetection generated in executing a similar teaching operation in other image processing apparatus(es), resulting in efficient prevention of occurrence of errors and misdetection as a whole as well as increase in reliability of examination of electronic components. This enables a brand new business in which the teaching data is managed by a manufacturer of image processing apparatuses, a manufacturer of mounting and examination apparatuses, or a third-party provider, and distributed on demand to the image processing apparatuses of each user of the mounting and examination apparatuses through Internet and the like. Since subject articles in the field of electronic component mounting are relatively standardized, most equipment used therein is also standardized. Consequently, as a business, there is expected a profit by sale of standard articles. Further, as for an examination function, with advance of an examination content and development of a sensing apparatus, most of the teaching data becomes complicated for bringing out the capability of the function to the fullest extent, so that the effect thereof is large.

According to the third aspect of the present invention, the teaching data created as a result of executing a teaching operation is electronically distributed so as to be used in the image processing apparatus that executed teaching and in an image processing apparatus other than the image processing apparatus. This implements highly efficient use of the teaching data in other image processing apparatus(es), and implements reduction of errors and misdetection, thereby making it possible to increase an operating ratio and mounting accuracy of the electronic component mounting apparatus. In other words, highly accurate recognition and examination may be performed only with use of the distributed teaching data without re-execution of the teaching operation in other image processing apparatus(es), thereby enabling omission or simplification of the teaching operation, while enabling prevention of errors and misdetection generated in executing a similar teaching operation in other image processing apparatus(es), resulting in efficient prevention of occurrence of errors and misdetection as a whole as well as increase in the operating ratio and mounting accuracy of the electronic component mounting apparatus. This enables a brand new business in which the teaching data is managed by a manufacturer of image processing apparatuses, a manufacturer of electronic component mounting apparatuses, or a third-party provider, and the teaching data is distributed on demand to the image processing apparatuses of each user of the electronic component mounting apparatuses through Internet and the like. Since subject articles in the field of electronic component mounting are relatively standardized, most equipment used therein is also standardized. Consequently, as a business, there may be expected a profit by sale of standard articles. Further, even if the electronic component mounting apparatuses are different in kind, the same kind of development is possible if image processing thereof is the same in kind.

According to the fourth aspect of the present invention, the teaching data created as a result of executing a teaching operation is distributed by a data distribution device that performs electronic distribution to enable use of the teaching data in the image processing apparatus that executed teaching and in an image processing apparatus(es) other than the image processing apparatus, which implements highly efficient use of the teaching data in other image processing apparatus(es), and implements reduction of errors and misdetection. In other words, highly accurate recognition and examination may be performed only with use of the teaching data distributed by the data distribution device without re-execution of the teaching operation in other image processing apparatus(es), thereby enabling omission or simplification of the teaching operation in other image processing apparatus(es), while enabling prevention of errors and misdetection generated in executing a similar teaching operation in other image processing apparatus(es), resulting in efficient prevention of occurrence of errors and misdetection as a whole. This enables a brand new business in which the teaching data is managed by a manufacturer of image processing apparatuses or a third-party provider, and distributed on demand to the image processing apparatuses of each user through Internet and the like.

According to the fifth aspect of the present invention, the teaching data created as a result of executing a teaching operation is distributed by a data distribution device that performs electronic distribution so that the teaching data is used in the image processing apparatus that executed teaching and in an image processing apparatus(es) other than the image processing apparatus for use in an examination apparatus in the field of electronic component mounting, which implements highly efficient use of the teaching data in other image processing apparatus(es), and implements reduction of errors and misdetection, thereby making it possible to increase reliability of the electronic component examination apparatus. In other words, highly accurate recognition and examination may be performed only with use of the distributed teaching data without re-execution of the teaching operation in other image processing apparatus(es), thereby enabling omission or simplification of the teaching operation, while enabling prevention of errors and misdetection generated in executing a similar teaching operation in other image processing apparatus(es), resulting in efficient prevention of occurrence of errors and misdetection as a whole as well as increase in reliability of examination of electronic components. This enables a brand new business in which the teaching data is managed by a manufacturer of image processing apparatuses, a manufacturer of mounting and examination apparatuses, or a third-party provider, and the teaching data is distributed on demand to the image processing apparatuses of each user of the mounting and examination apparatuses through Internet and the like. Since subject articles in the field of electronic component mounting are relatively standardized, most equipment used therein is also standardized. Consequently, as a business, there may be expected a profit by sale of standard articles. Further, as for an examination function, with advance of an examination content and development of a sensing apparatus, most of the teaching data becomes complicated for bringing out the capability of the function to the fullest extent, so that the effect thereof is large.

According to the sixth aspect of the present invention, the teaching data created as a result of executing a teaching operation is distributed by an apparatus that performs electronic distribution to enable use of the teaching data in the image processing apparatus that executed teaching and in an image processing apparatus(es) other than the image processing apparatus for detecting positions of electronic components in an electronic component mounting apparatus. This implements highly efficient use of the teaching data in other image processing apparatus(es), and implements reduction of errors and misdetection, thereby making it possible to increase an operating ratio and mounting accuracy of the electronic component mounting apparatus. In other words, highly accurate recognition and examination may be performed only with use of the distributed teaching data without re-execution of the teaching operation in other image processing apparatus(es), thereby enabling omission or simplification of the teaching operation, while enabling prevention of errors and misdetection generated in executing a similar teaching operation in other image processing apparatus(es), resulting in efficient prevention of occurrence of errors and misdetection as a whole as well as increase in the operating ratio and mounting accuracy of the electronic component mounting apparatus. This enables a brand new business in which the teaching data is managed by a manufacturer of image processing apparatuses, a manufacturer of electronic component mounting apparatuses, or a third-party provider, and the teaching data is distributed on demand to the image processing apparatuses of each user of the electronic component mounting apparatuses through Internet and the like. Since subject articles in the field of electronic component mounting are relatively standardized, most equipment used therein is also standardized. Consequently, as a business, there may be expected a profit by sale of standard articles. Further, if the electronic component mounting apparatuses are different in kind, the same kind of development is possible if their image processing is the same in kind.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A method of distributing teaching data for an image processing apparatus, comprising:
creating teaching data containing data specific to an image processing apparatus that executed a teaching operation, based on a result of the teaching operation for recognizing and examining a subject component in the image processing apparatus; and
electronically distributing the created teaching data to another image processing apparatus other than the image processing apparatus that executed teaching to enable use of the teaching data for image processing in the another image processing apparatus.

2. The method of distributing teaching data for an image processing apparatus as defined in claim 1, wherein the subject component is an electronic component sucked by a suction nozzle for an electronic component mounting apparatus in a field of electronic component mounting, and the image processing in the image processing apparatus is image-processing in an examination apparatus for recognizing and examining the electronic component.

3. The method of distributing teaching data for an image processing apparatus as defined in claim 1, wherein the subject component is an electronic component sucked by a suction nozzle for an electronic component mounting apparatus in a filed of electronic component mounting, and the image processing in the image processing apparatus is used for position detection processing of the electronic component in an electronic component mounting step.

4. A system of distributing teaching data for an image processing apparatus, comprising:
a teaching data creation device for creating teaching data containing data specific to an image processing apparatus that executed a teaching operation, based on a result of the teaching operation for recognizing and examining a subject component; and
a distribution device for electronically distributing the teaching data created by the teaching data creation device to another image processing apparatus other than the image processing apparatus that executed teaching to enable use of the teaching data for image processing in the another image processing apparatus.

5. The system of distributing teaching data for an image processing apparatus as defined in claim 4, wherein the subject component is an electronic component sucked by a suction nozzle for an electronic component mounting apparatus in a filed of electronic component mounting, and the image processing apparatus is provided on an examination apparatus for recognizing and examining the electronic component.

6. The system of distributing teaching data for an image processing apparatus as defined in claim 4, wherein the subject component is an electronic component sucked by a suction nozzle for an electronic component mounting apparatus in a filed of electronic component mounting, and the image processing in the image processing apparatus is used for position detection processing of the electronic component in an electronic component mounting step.

7. The method of distributing teaching data for an image processing apparatus as defined in claim 1, wherein the teaching operation comprises of:
sucking an electronic component to be mounted on a circuit forming body, by a suction nozzle; and
recognizing and examining the electronic component sucked by the suction nozzle as the subject component in the image processing apparatus.

8. The system of distributing teaching data for an image processing apparatus as defined in claim 4, wherein the teaching operation by the teaching data creation device comprises of sucking an electronic component to be mounted on a circuit forming body, by a suction nozzle, and recognizing and examining the electronic component sucked by the suction nozzle as the subject component in the image processing apparatus.
